(19) United States
(12) Patent Application Publication
(10) Pub. No.: US 2011/0232002 A1
(43) Pub. Date: Sep. 29, 2011

(54) TPU Compositions For Melt Coating Processes

(75) Inventor: Robert J. Wiessner, Bladel (NL)

(73) Assignee: LUBRIZOL ADVANCED MATERIALS, INC., Cleveland, OH (US)

(21) Appl. No.: 13/120,747

(22) PCT Filed: Sep. 2, 2009
(86) PCT No.: PCT/US09/55651

§ 371 Date: Jun. 8, 2011

Related U.S. Application Data
(60) Provisional application No. 61/099,690, filed on Sep. 24, 2008.

(51) Int. Cl. B32B 5/02; C08L 75/08; C08L 75/06; B32B 1/02; B05D 3/00; B63B 35/58; A47C 27/08; B63C 9/125; B65G 15/30

(52) U.S. Cl. 5/706; 525/458; 525/450; 442/59; 442/172; 428/36.1; 427/374.4; 441/40; 441/106; 198/844.1

(57) ABSTRACT

A TPU composition comprising two or more TPU polymers is disclosed. The TPU composition gives a broad process window for melt coating applications. The blend of TPUs give better processing than either of the individual TPU polymers used in the blend alone. This results in melt coating which gives less matt and glossy streaks and allows faster coating speeds along with lower coating weight. The two or more TPU polymers used in the blend have a different soft segment. The different soft segment is created by using different molecular weight polyol for the TPU polymers or by using chemically different polyols.

### FIELD OF THE INVENTION

The present invention relates to thermoplastic polyurethane (TPU) compositions comprising a blend of two or more fully formed TPU polymers. The two or more TPU polymers used in the blend have different melt characteristics. The TPU compositions are useful for use in melt coating processes where the TPU composition is coated on a fabric substrate or to make a film from the TPU composition.

### BACKGROUND OF THE INVENTION

Thermoplastic polyurethane (TPU) polymers have found many industrial uses because of their excellent properties, such as strength, elongation, toughness, abrasion resistance, and ease of processing. One such use is in the making of films to melt coat fabrics for various end use applications.

The melt coating processes frequently used is either an extrusion melt coating or a calender melt coating process. Current TPU polymers used in these processes have some limitations such as when one wishes to coat a fabric substrate with a thin coating, having less than 150 μm layer of TPU. Also, frequently the TPU coating will need to be processed through an embossing step to correct matt and glossy areas of the coating.

Processors desire to perform their melt coating process in one pass. If low coating weight is desired with prior TPUs, often a second step of embossing is required to disguise glossy and matt streaks caused by the prior art TPUs. Thick coatings (greater than 350 μm) of prior art TPU can also present problems in having a defect free coating.

Processors of TPU for melt coating also desire to operate their equipment at higher speeds as well as with lower coating weight for greater efficiency and cost savings.

It would be desirable to have a TPU composition that could be processed to achieve a lower coating thickness, such as 25 μm to 150 μm, as well as a thick coating of from 300 to 400 μm, while increasing the processing speed. Of course, the TPU composition should also be capable of making medium thickness coatings, such as 150 to 300 μm, as well as the thin and thick coating. Quality films that could be made with one pass are also desirable.

### SUMMARY OF THE INVENTION

This invention relates to a thermoplastic polyurethane (TPU) composition comprising a blend of two or more fully formed TPU polymers. The blend has from 10 to 90 weight percent of a first fully formed TPU polymer and from 90 to 10 eight percent of a second fully formed TPU polymer. The weight percent is based on the total weight of all TPU polymers in the TPU composition. Preferably, the weight percent of the first fully formed TPU polymer is from 20-80 weight percent and the second fully formed TPU polymer is from 80-20 weight percent. More preferably, the weight percent of the first fully formed TPU polymer is from 40-60 weight percent and the second fully formed TPU polymer is from 60-40 weight percent.

The first TPU polymer and the second TPU polymer are both made from the reaction of (a) at least one hydroxyl terminated intermediate, known as a polyol, (b) at least one chain extender, and (c) at least one diisocyanate. Both TPU polymers have a soft segment formed from the polyol and a hard segment formed from the chain extender reacted with the diisocyanate.

The soft segment of the two TPU polymers is different. The difference in soft segment can be made by using a different number average molecular weight polyol. The difference in Mₙ of the polyols should be at least 500 Dalions, preferably at, least 750 Daltons, and more preferably at least 1000 Daltons. The difference in the soft segment can also be made by having a chemically different soft segment. By chemically different, it is meant that the soft segments have different chemical groups. For example, one of the TPUs can have a polyester soft segment while the other TPU can have a polyether soft segment.

It is an object of the present invention to have a TPU composition which can be used to melt coat a fabric substrate and to have the TPU composition exhibit a broad process window. This allows the melt coating to be accomplished with a low coating weight, that is, having a coating thickness as thin as 25 μm. The melt coating process can be run at higher speeds and good coating quality can be obtained in one pass through the coating process.

To accomplish this objective, a TPU composition having a blend of at least two different TPU polymers are used, as described above.

It is also an object of the present invention to produce a coated fabric article by using the TPU composition having a blend of at least two different TPU polymers. The coated fabric can be used to produce flexible containers, inflatable life vests and rafts, conveyor belts, inflatable an mattresses, printing; blankets and adhesive laminates.

### DETAILED DESCRIPTION OF THE INVENTION

The thermoplastic polyurethanes (TPU for short) compositions of the present invention comprise at least two fully formed TPU polymers. A fully formed TPU polymer means a TPU polymer that has been made by the reaction of at least one hydroxyl terminated intermediate (also known as a polyol), at least one chain extender, and at least one diisocyanate. The preceding reactants are reacted to form a TPU polymer having a weight average molecular weight of at least 50,000 Daltons. The TPU polymer is cut into pellets, ground in powder, or formed into other small size pieces.

The TPU composition of the present invention is formed by blending two or more fully formed TPU polymers. Preferably, two TPU polymers in pellet form are used and the pellets are dry blended together to create a blend of the pellets to form the TPU composition of this invention.

The TPU polymers used in this invention can be any conventional TPU polymer that, is known to the art and in the literature as long as the TPU polymer has adequate molecular weight. The TPU polymer is generally prepared, by reacting a diisocyanate with an intermediate such as a hydroxyl terminated polyester, a hydroxyl terminated polyether, a hydroxyl terminated polycarbonate or mixtures thereof, with one or more chain extenders, all of which are well known to those skilled in the art.

The hydroxyl terminated polyester intermediate is generally a linear polyester having a number average molecular weight (Mn) of from about 500 to about 10,000 Daltons, desirably from about 700 to about 5,000, and preferably from about 700 to about 4,000, an acid number generally less than 1.3 and preferably less than 0.8. The molecular weight is determined by assay of the terminal functional groups and is related to the number average molecular weight. The polymers are produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from—caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is the preferred acid. The glycols which are reacted to form a desirable polyester intermediate can be aliphatic, aromatic, or combinations thereof, and have a total of from 2 to 12 carbon atoms, and include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, cyclohexanedimethanol, decamethylene glycol, dodecamethylene glycol, and the like, 1,4-butanediol is the preferred glycol.

Hydroxyl terminated polyether intermediates are polyether polyols derived from a diol or polyol having a total of from 2 to 15 carbon atoms, preferably an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, poly(propylene glycol) comprising propylene oxide reacted with propylene glycol, poly(tetramethyl glycol) comprising water reacted with tetrahydrofuran (PTMG). Polytetramethylene ether glycol (PTMEG) is the preferred polyether intermediate. Polyether polyols further include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the current invention. Typical copolyethers include the reaction product of THF and ethylene oxide or THF and propylene oxide. These are available from BASF as Poly THF B, a block copolymer, and poly THF R, a random copolymer. The various polyether intermediates generally have a number average molecular weight (Mn), as determined by assay of the terminal functional groups which is an average molecular weight, of from about 500 to about 10,000 Daltons, desirably from about 500 to about 5,000, and preferably from about 700 to about 3,000.

The polycarbonate-based polyurethane polymer of this invention is prepared by reacting a diisocyanate with a blend of a hydroxyl terminated polycarbonate and a chain extender. The hydroxyl terminated polycarbonate can be prepared by reacting a glycol with a carbonate.

U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and preferably 4 to 12 carbon atoms, and from polyoxyalkylene glycols containing 2 to 20 alkoxy groups per molecular with each alkoxy group containing 2 to 4 carbon atoms. Diols suitable for use in the present invention include aliphatic diols containing 4 to 12 carbon atoms such as butanediol-1,4, pentanediol-1,4, neopentyl glycol, hexanediol-1,6, 2,2,4-trimethylhexanediol-1,6, decanediol-1,10, hydrogenated dilinoleylglycol, hydrogenated dioleylglycol; and cycloaliphatic diols such as cyclohexanediol-1,3, dimethylolcyclohexane-1,4, cyclohexanediol-1,4, dimethylolcyclohexane-1,3,1,4-endomethylene-2-hydroxy-5-hydroxymethyl cyclohexane, and polyalkylene glycols. The diols used in the reaction may be a single diol or a mixture of diols depending on the properties desired in the finished product.

Polycarbonate intermediates which are hydroxyl terminated are generally those known to the art and in the literature. Suitable carbonates are selected from alkylene carbonates composed of a 5 to 7 membered ring having the following general formula:

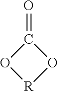

where R is a saturated divalent radical containing 2 to 6 linear carbon atoms. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate.

Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate, Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Preferred examples of diarylcarbonates, which can contain 6 to 20 carbon atoms in each aryl group, are diphenylcarbonate, ditolylcarbonate, and dinaphthylcarbonate.

The reaction is carried out by reacting a glycol with a carbonate, preferably an alkylene carbonate in the molar range of 10:1 to 1:10, but preferably 3:1 to 1:3 at a temperature of 100° C. to 300° C.′ and at a pressure in, the range of 0.1 to 300 mm of mercury in the presence or absence of an ester interchange catalyst, while removing low boiling glycols by distillation.

More specifically, the hydroxyl terminated polycarbonates are prepared in two stages. In the first stage, a glycol is reacted with an alkylene carbonate to form a low molecular weight hydroxyl terminated polycarbonate. The lower boiling point glycol is removed by distillation at 100° C. to 300° C., preferably at 150° C. to 250° C., under a reduced pressure of 10 to 30 mm Hg, preferably 50 to 200 mm Hg. A fractionating column is used to separate the by-product glycol from the reaction mixture. The by-product glycol is taken off the top of the column and the unreacted alkylene carbonate and glycol reactant are returned to the reaction vessel as reflux. A current of inert gas or an inert solvent can be used to facilitate removal of by-product glycol as it is formed. When amount of by-product glycol obtained indicates that degree of polymerization of the hydroxyl terminated polycarbonate is in the range of 2 to 10, the pressure is gradually reduced to 0.1 to 10 mm Hg and the unreacted glycol and alkylene carbonate are removed. This marks the beginning of the second stage of reaction during which the low molecular weight hydroxyl terminated polycarbonate is condensed by distilling off glycol as it is funned at 100° C. to 300° C., preferably 150° C. to 250° C. and at a pressure of 0.1 to 10 mm Hg until the desired molecular weight of the hydroxyl terminated polycarbonate is attained. Molecular weight (Mn) of the hydroxyl terminated polycarbonates can vary from about 500 to about 10,000 but in a preferred embodiment, it will be in the range of 500 to 2500.

Suitable extender glycols (i.e., chain extenders) are lower aliphatic or short chain glycols having from about 2 to about 10 carbon atoms and include for instance ethylene glycol, diethylene glycol, propylene glycol, dipropylene glycol, 1,4-butanediol, 1,6-hexanediol, 1,3-butanediol, 1,5-pentanediol, 1,4-cyclohexanedimethanol hydroquinone di(hydroxyethyl)ether, neopentyglycol, and, the like, with 1,4-butanediol being preferred.

The desired TPU polymer used in the TPU composition of this invention is generally made from the above-noted intermediates such as a hydroxyl terminated polyesters, polyether, or polycarbonate, preferably polyether, which is further reacted with a polyisocyanate, preferably a diisocyanate, along with extender glycol desirably in a so-called one-shot process or simultaneous coreaction of polyester, polycarbonate or polyether intermediate, diisocyanate, and extender glycol to produce a high molecular weight linear TPU polymer. The preparation of the macroglycol is generally well known to the art and to the literature and any suitable method may be used. The weight average molecular weight (Mw) of the TPU polymer is generally about 50,000 to 800,000, and preferably from about 70,000 to about 250,000 Daltons. The equivalent weight amount of diisocyanate to the total equivalent weight amount of hydroxyl containing components, that is the hydroxyl terminated polyester, polyether, or poycarbonate, and chain extender glycol, is from about 0.95 to about 1.10, desirably from about 0.96 to about 1.02, and preferably from about 0.97 to about 1.005. Suitable diisocyanates include aromatic diisocyanates such as 4,4′-methylenebis-(phenyl isocyanate) (MDI), m-xylylene diisocyanate (XDI), phenylene-1,4-diisocyanate, naphthalene-1,5-diisocyanate, diphenylmethane-3,3′-dimethoxy-4,4′-diisocyanate and toluene diisocyanate (TDI); as well as aliphatic diisocyanates such as isophorone diisocyanate (IPDI), 1,4-cyclohexyl diisocyanate (CHDI), decane-1,10-diisocyanate, and dicyclohexylmethane-4,4′-diisocyanate. The most preferred diisocyanate is 4,4′-methylenebis(phenyl isocyanate), MDI. When a higher molecular weight TPU polymer is desired, it can be achieved by using a small amount of a cross linking agent having a functionality greater than 2.0 to induce cross linking. The amount of cross linking agent used is preferably less than 2 mole percent of the total moles of chain extender, and more preferably less than 1 mole percent. A particularly desirable method to increase the molecular weight in the preferred TPU polymer is to replace less than 1 mole percent of the 1,4-butanediol chain extender with trimethylol propane (TMP).

In the one-shot polymerization process which generally occurs in situ, a simultaneous reaction occurs between three components, that is, the one or more intermediates, the one or more diisocyanates, and the one or more extender glycols, with the reaction generally being initiated at temperatures of from about 100° C. to about 120° C. Inasmuch as the reaction is exothermic, the reaction temperature generally increases to about 220° C.-250″C.

The TPU polymers in the TPU compositions of this invention have a weight average molecular weight (Mw), as measured according to gel permeation chromatography (GPC) against polystyrene standard, of from about 50,000 to about 800,000 Daltons, preferably from about 70,000 to about 250,000 Daltons.

The TPU composition comprises a blend of two or more TPU polymers, preferably two TPU polymers. Both TPU polymers used are fully formed TPU polymers, that is they each have a weight average molecular weight of 50,000 Daltons or greater. The two TPU polymers are different polymers. The difference in the TPU polymers can be a difference in the number average molecular weight of the soft segment (polyol) of the TPUs. The difference between the molecular weight of the polyol used to make the TPUs should be at least 500 Daltons, preferably at least 750 Daltons, and more preferably about 1000 Daltons. The TPUs in the composition can also be different chemically. That is, one TPU polymer can be a polyester TPU (has a polyester soft segment) while the other TPU polymer can be a polyether TPU (has a polyether soft segment).

In TPU polymers, a higher polyol molecular weight, gives greater degree of phase separation between the hard block and the soft block of the polymer. The hard block will be better defined and cause higher inciting characteristics. The Tc will be sharper and higher and the Tg will be lower with a higher Mn polyol. It is believed that because the TPU polymers used in the TPU composition are different, they have different melt properties. Because the TPU polymers have different melt properties, they are somewhat incompatible from a melt standpoint and this feature leads to the good processing at low coating weight. The different melt properties of the TPU polymers allow the composition to be processed in a melt coating at a lower coating weight and at faster speeds. The different melt properties of the TPU polymers can be achieved by using different Mn polyols when making the TPUs, as described above or the difference can be achieved by the polyols being chemically different, such as one polymer being a polyester TPU and the other polymer being a polyether TPU.

The TPU composition of this invention is made by blending a first fully formed TPU polymer with a second fully formed TPU polymer. The first and second TPU polymer can each be made and pelletized into pellet form. The pellets of each TPU polymer can be dry blended to form the TPU composition. The two polymers could also be mixed together in a melt mixing machine, such as an extruder, and the mixture be pelletized to form the TPU composition in pellet form. The level of the first TPU polymer in the TPU composition is from 90 to 10 weight percent, preferably from 80 to 20 weight percent, and more preferably from 60 to 40 weight percent. The level of the second fully formed TPU polymer is from 10 to 90 weight percent, preferably from 20 to 80 weight percent, and more preferably from 40 to 60 weight percent.

The TPU composition, either in the form of a blend of pellets of both TPU polymers or as a homogeneous pellet containing both TPU polymers is fed to a melt coating equipment. The melt coating equipment can be any of those known to those skilled in the art of melt coating, such as a calender or extrusion melt coating. The extrusion flat die process or extrusion blown film process can be used to achieve an unsupported film as thin as 25 μm. The thin film can be applied to fabric with heat and pressure or used in other film applications. The TPU composition is melt processed through the melt processing equipment to form a film which can be collected in the form of a film or preferably applied hot to a fabric substrate, to create a TPU coated fabric.

The coating thickness is usually from about 25 μm to about 400 μm, preferably from about 90 μm to about 350 μm.

The coated fabric can be used to make flexible containers, inflatable life vests, inflatable rafts, conveyor belts, inflatable air mattresses, printing blankets, adhesive laminates, and the like.

The fabric that can be coated with the TPU composition of this invention can be any of the normal fabrics, such as organic or inorganic fabrics. Examples of organic fabrics include nylon, polyester, polypropylene, and carbon. Examples of inorganic fabrics include glass and steel.

It is quite surprising that the blend of TPU polymers processed even better than either TPU polymer individually. Also, when a single TPU polymer was made by mixing the polyols to arrive at a single TPU polymer which had the same composition as the blend of two TPU polymers, the single TPU polymer did not process in the melt coating process as well as the blend TPU composition of this invention.

The TPU composition can contain other ingredients, other than TPU polymers. Ingredients such as coloring agents, flame retardants, UV and heat stabilizers, wax, and the like, can be added to the TPU composition. The addition of ingredients can be made to one or both of the TPU polymers when they are being made or can be added during the melt processing of the blend of the two TPU polymers to form the TPU composition.

The invention will be better understood by referring to the following examples.

### EXAMPLES

Three separate TPU polymers were produced by the one-shot process as follows:
TPU Polymer 1—was a polyether TPU, made by reacting, a 2000 Mn PTMEG polyol, 1,4-butanediol, and MDI. The polymer produced had a Mw of 120,000 Daltons and a Shore A durometer of 75.
TPU Polymer 2—was a polyether TPU, made by reacting a 1000 Mn PTMEG polyol, 1,4-butanediol, and MDI. The polymer produced had a Mw of 120,000 Daltons and a Shore A durometer of 82.
TPU Polymer 3—was a polyester TPU, made by reacting a 1000 Mn polybutylene adipate polyol, ethylene glycol, and MDI. The polymer had a Mw of 110,000 Daltons and a Shore A durometer of 70.
   The TPU polymers (1-3) were evaluated individually and as blends for melt processing as shown below.

### Examples 1-6

### Comparative Examples 7-9

TPU blends were created by dry blending pellets of the TPU polymers. The ratio (by weight) of the 6 blends are shown in Table I below as well as 3 comparative examples with only 1 TPU polymer:

TABLE I

| | | | | | | | Example 7 | Example 8 | Example 9 |
|---|---|---|---|---|---|---|---|---|---|
| | Example 1 | Example 2 | Example 3 | Example 4 | Example 5 | Example 6 | (Comparative) | (Comparative) | (Comparative) |
| Polymer 1 | 80 | 70 | 60 | 15 | 30 | 40 | 100 | — | — |
| Polymer 2 | 20 | 30 | 40 | — | — | — | — | 100 | — |
| Polymer 3 | — | — | — | 85 | 70 | 60 | — | — | 100 |

The blends (Examples 1-6) and comparative single polymers (Comparative Examples 7-9) were evaluated in a pilot extruder-melt roll coating line to determine the processability of the blends. The extruder used was a co-rotating twin screw with a 35 L/D screw. The melt roll coater used was a 2 bowl inclined, 80 cm wide. The extruder temperature profile was 175° C. to 160° C. and the melt coater bowl temperature was 140° C. to 160″C. The coat width was set at 50 cm.

The blends and the comparative (single polymer) examples were evaluated for (a) stable melt viscosity and strength to facilitate conveyance of an extruded melt rope to the 2 bowl melt roll coater, (b) the nip-pressure to obtain a coat thickness of 100 g/m² (90 μm) at 5 m/min, coating speed, and (c) the % increase in coating weight as coating speed was increased from 5 m/min, to 8 m/min, and 12 m/min.

The results are shown in Table II below:

TABLE II

| | | | | | | | (Comparative) | (Comparative) | (Comparative) |
|---|---|---|---|---|---|---|---|---|---|
| | Example 1 | Example 2 | Example 3 | Example 4 | Example 5 | Example 6 | Example 7 | Example 8 | Example 9 |
| Nip-Pressure at | 68 | 66 | 66 | 67 | 67 | 67 | 70 | 70 | 44 |
| Coating Speed | | | | | | | | | |
| of 5 m/min. (kN) | | | | | | | | | |
| % Coating Weight | | | | | | | | | |
| Increase at: | | | | | | | | | |
| 8 m/min. | 55 | 50 | 50 | 40 | 35 | 45 | 75 | 70 | 70 |
| 12 m/min. | 140 | 110 | 90 | 65 | 65 | 70 | 250 | 240 | 140 |
| Melt Stability | OK | OK | NOT | OK | OK | OK | OK | OK | OK |
| (Visual) | | | OK | | | | | | |

### Discussion of Results

From the data, it can be seen that all of the Examples, except Example 3, extrude and appear as stable, easy conveyable melts. When the coating speed is increased at a fixed nip pressure, the coating weight increases. The coat weight increase is another measure for the melt elasticity of the TPUs and a processability indicator. Comparative Examples 7 and 8 were blended to form Examples 1, 2 and 3. It can be seen from the data that Examples 1, 2 and 3 had a much less increase in the coating weight as the speed was increased, compared to the Comparative Examples 7 and 8.

### Example 10

In this Example 10, the blend of Example 2 (70% polymer 1 and 30% polymer 2) was scaled up to further evaluate processability in an extrusion-melt coating line. A co-rotating, 28 L/D ratio twin screw extruder was used with a 220 cm wide, 2 howl inclined melt roll coater set-up was used. The melt was fed to the melt coater at a temperature of 175° C. The trial yielded a coating weight of 100 g/m² on textile at a line speed of 12 m/min. at about 20% tower nip pressure than used to produce 150 g/m² coat weight of polymer 2 at a line speed of 10 m/min.

### Example 11

In this Example 11, two commercial calender grade TPU polymers were obtained from Lubrizol Advanced Materials, Inc. One TPU polymer was known as Estane® 54640 NAT 031 (Polyether TPU) and the second TPU polymer was known as Estane® 54600 NAT 021 (Polyester TPU). The two polymers were blended in a 90/10 (54640 NAT 031/54600 NAT 021) mixture and an 80/20 mixture. The mixtures were evaluated against 100% Estane® 54640 NAT 031, which was the majority polymer in the two blends. A three roll calender coater was used for the evaluation. A speed of 4 m/min. and a coating thickness of 250 μm were used. The results showed that the control (Estane® 54640 NAT 031) had matt and glossy streaks in the coating and required re-embossing in an additional pass to make acceptable coating. The 90/10 mixture of TPUs was much improved, but still had some streaks visible. Re-embossing was still required to make a high quality coating.

The 80/20 mixture of TPUs gave a high quality coating free of matt and glossy streaks and did not require re-embossing.

### Example 12

### In this Example 12, a single TPU polymer was made which had the same composition as the blend of polymers. That is, the two different polyols were mixed together and reacted with 1,4-butanediol and MDI to create a single TPU polymer with the same composition as the blend of two different TPU polymers.

The single TPU polymer processed very much like the comparative examples above, which used one polymer. The processing benefits exhibited by the TPU blends of this invention (lower coating weight, faster speed, and defect free) were not observed in the single TPU which had the same chemical composition. This is very surprising results and shows there are processing synergies obtained by blending two TPU polymers in the melt coating process.

### Example 13

In this Example 13, a 50/50 blend was used of TPU polymer 1 (polyether TPU made with a 2000 Mn PTMEG polyol) and TPU polymer 2 (polyether TPU made with a 1000 Mn PTMEG polyol). The pellets of the two TPU polymers were dry blended to form the TPU composition. The blend was melt coated on fabric at a coating thickness of 120 μm with good results. A composition containing only TPU polymer 2 was not able to make acceptable coatings of less than 150 μm.

While in accordance with the Patent Statutes, the best mode and preferred embodiment has been set forth, the scope of the invention is not limited thereto, but rather by the scope of the attached claims.

What is claimed is:

1. A thermoplastic polyurethane (TPU) composition comprising a blend of two or more fully formed TPU polymers, said blend comprising from 10 to 90 weight percent of a first fully formed TPU polymer and from 90 to 10 weight percent of a second fully formed TPU polymer, said weight percent based on the total weight of said first and said second TPU polymer; whet both said first TPU polymer and said second TPU polymer have a soft segment and a hard segment and said first and second TPU polymers are both derived from the reaction of:
(a) at least one hydroxyl terminated intermediate to form said soft segment;
(b) at least one chain extender; and
(c) at least one diisocyanate, wherein said hard segment is formed by said chain extender and said diisocyanate; and wherein said first TPU polymer is made from either (i) a different number average molecular weight hydroxy terminated intermediate, said difference in number average molecular weight being at least 500 Daltons, or (ii) a chemically different hydroxy terminated intermediate, from said second TPU polymer.

2. The TPU composition of claim 1, wherein said blend comprises from 20 to 80 weight percent of said first fully formed TPU polymer and 80 to 20 weight percent of said second fully formed TPU polymer.

3. The TPU composition of claim 2, wherein said blend comprises from 30 to 70 weight percent of said first fully formed TPU polymer and 70 to 30 weight percent of said second fully formed TPU polymer.

4. The TPU composition of claim 1, wherein said first TPU polymer is made from a hydroxy terminated intermediate having a different number average molecular weight from the hydroxy terminated intermediate used to make said second TPU polymer, said difference in number average molecular weight being at least 750 Daltons.

5. The TPU composition of claim 4, wherein said difference in number average molecular weight is at least 1000 Daltons.

6. The TPU composition of claim 1, wherein said hydroxy terminated intermediate is selected from the group consisting of polyester, polyether and polycarbonate.

7. The TPU composition of claim 6, wherein said hydroxy terminated intermediate is polyether.

8. The TPU composition of claim 1, wherein said chain extender is selected from the group selected from straight chain glycols having from 2 to 8 carbon atoms.

9. The TPU composition of claim 1, wherein said diisocyanate is 4,4′-methylene bis-(phenyl isocyanate).

10. The TPU composition of claim 1, wherein said first fully formed TPU polymer is a polyether polyurethane and said second fully formed TPU polymer is a polyester polyurethane.

11. The TPU composition of claim 1, wherein said first and said second fully formed TPU polymers are both polyether TPU polymers, and wherein said first fully formed TPU polymer was made with a 2000 Mn hydroxy terminated intermediate and said second fully formed TPU polymer was made with 1000 Mn hydroxy terminated intermediate, and said composition is formed from a 50/50 blend of said first and said second fully formed TPU polymers.

12. A process for producing a thermoplastic polyurethane (TPU) film by either a melt coating process or a calenclering process, said process comprising:
(A) blending two or more fully formed TPU polymers to create a blend, said blend comprising from 10 to 90 weight percent of a first fully funned TPU polymer and from 90 to 10 weight percent of a second fully formed TPU polymer, said weight percent based on the total weight of said first and said second TPU polymers; and
(B) melt processing said blend to form a TPU film;
wherein both said first TPU polymer and said second TPU polymer have a soft segment and a hard segment and both said first and said second TPU polymers are derived from the reaction of:
(a) at least one hydroxyl terminated intermediate to form said soft segment;
(b) at least one chain extender; and
(c) at least one diisocyanate, wherein said hard segment is formed by said chain extender and said diisocyanate; and
wherein said first TPU polymer is made from either (i) a different number average molecular weight hydroxy terminated intermediate, said difference in number average molecular weight being at least 500 Daltons, or (ii) a chemically different hydroxy terminated intermediate, from said second TPU polymer.

13. The process of claim 12, wherein said blend comprises from 20 to 80 weight percent of said first fully formed TPU polymer and 80 to 20 weight percent of said second fully formed TPU polymer.

14. The process of claim 13, wherein said blend comprises from 30 to 70 weight percent of said first fully formed TPU polymer and 70 to 30 weight percent of said second fully formed TPU polymer.

15. The process of claim 12, wherein said first TPU polymer is made from a hydroxy terminated intermediate having a different number average molecular weight from the hydroxy terminated intermediate used to make said second TPU polymer, said difference in number average molecular weight being at least 750 Daltons.

16. The process of claim 15, wherein said difference in number average molecular weight is at least 1000 Daltons.

17. The process of claim 12, wherein said hydroxy terminated intermediate is selected from the group consisting of polyester, polyether and polycarbonate.

18. The process of claim 17, wherein said hydroxy terminated intermediate is polyether.

19. The process of claim 12, wherein said chain extender is selected from the group selected from straight chain glycols having from 2 to 8 carbon atoms.

20. The process of claim 12, wherein said diisocyanate is 4,4′-methylene bis-(phenyl isocyanate).

21. The process of claim 12, wherein said first fully formed TPU polymer is a polyether polyurethane and said second fully formed TPU polymer is a polyester polyurethane.

22. A process for producing a coated fabric comprising coating a fabric substrate with a thermoplastic polyurethane (TPU) composition wherein said TPU composition comprises a blend of at, least two different TPU polymers, said blend comprising from 10 to 90 weight percent of a first fully formed TPU polymer and from 90 to 10 weight percent of a second fully formed TPU polymer, said weight percent based on the total weight of said first and said second TPU polymers; said process comprising:
(A) blending said first frilly formed TPU polymer with said second fully formed TPU polymer;
(B) mixing said blend in a melt processing equipment to create a polymer melt; and
(C) coating a fabric substrate with said polymer melt to form a coating film of TPU on said fabric substrate;
wherein both said first TPU polymer and said second TPU polymer have a soft segment and a hard segment and both said first and said second TPU polymers are derived from the reaction of:
(a) at least one hydroxyl terminated intermediate to form said soft segment;
(b) at least one chain extender; and
(c) at least one diisocyanate, wherein said hard segment is formed by said chain extender and said diisocyanate; and
wherein said first TPU polymer is made from either (i) a different number average molecular weight hydroxy terminated intermediate, said difference in number average molecular weight being at least 500 Daltons, or (ii) a chemically different hydroxy terminated intermediate, from said second TPU polymer.

23. The process of claim 22, wherein said blend comprises from 20 to 80 weight percent of said first fully formed TPU polymer and 80 to 20 weight percent of said second fully formed TPU polymer.

24. The process of claim 23, wherein said blend comprises from 30 to 70 weight percent of said first fully formed TPU polymer and 70 to 30 weight percent of said second fully formed TPU polymer.

25. The process of claim 22, wherein said first TPU polymer is made from a hydroxy terminated intermediate having a different number average molecular weight from the hydroxy terminated intermediate used to make said second TPU polymer, said difference in number average molecular weight being at least 750 Daltons.

26. The process of claim 25, wherein said difference in number average molecular weight is at least 1000 Daltons.

27. The process of claim 22, wherein said hydroxy terminated intermediate is selected from the group consisting of polyester, polyether and polycarbonate.

28. The process of claim 27, wherein said hydroxy terminated intermediate is polyether.

29. The process of claim 22, wherein said chain extender is selected from the group selected from straight chain glycols having from 2 to 8 carbon atoms.

30. The process of claim 22 wherein said diisocyanate is 4,4′-methylene his-(phenyl isocyanate).

31. The process of claim 22, wherein said first, fully formed TPU polymer is a polyether polyurethane and said second fully formed TPU polymer is a polyester polyurethane.

32. The process of claim 22, wherein said coating film of TPU has a thickness of from about 25 μm to about 400 μm.

33. The process of claim 32, wherein said coating film of TPU has a thickness of from about 90 μm to about 350 μm.

34. The process of claim 22, wherein said coating step (c) is performed in one pass through said coating operation.

35. The process of claim 22, wherein said fabric is made from fibers selected from the group consisting of organic fibers and inorganic fibers.

36. A coated fabric article comprising a fabric substrate and a topcoat of thermoplastic polyurethane (TPU) polymer film; wherein said TPU film is made from a blend of at least two fully formed TPU polymers, said blend comprising from 10 to 90 weight percent of a first fully formed TPU polymer and from 90 to 10 weight percent of a second fully formed TPU polymer, said weight percent based on the total weight of said first and said second TPU polymer;
wherein both said first TPU polymer and said second TPU polymer have a soft segment and a hard segment and both said first and said second TPU polymers are derived from the reaction of
(a) at least one hydroxyl terminated intermediate to form said soft segment;
(h) at least one chain extender; and
(c) at least one diisocyanate, wherein said hard segment is formed by said chain extender and said diisocyanate; and
wherein said first TPU polymer is made from either (i) a different number average molecular weight hydroxy terminated intermediate, said difference in number average molecular weight being at least 500 Daltons, or (ii) a chemically different hydroxy terminated intermediate, from said second TPU polymer.

37. The article of claim 36, wherein said blend comprises from 20 to 80 weight percent of said first fully formed TPU polymer and 80 to 20 weight percent of said second fully formed TPU polymer.

38. The article of claim 37, wherein said blend comprises from 30 to 70 weight percent of said first fully formed TPU polymer and 70 to 30 weight percent of said second fully formed TPU polymer.

39. The article of claim 36, wherein said first TPU polymer is made from a hydroxy terminated intermediate having a different number average molecular weight from the hydroxy terminated intermediate used to make said second TPU polymer, said difference in number average molecular weight being at least 750 Daltons.

40. The article of claim 39, wherein said difference in number average molecular weight is at least 1000 Daltons.

41. The article of claim 36, wherein said hydroxy terminated intermediate is selected from the group consisting of polyester, polyether and polycarbonate.

42. The article of claim 41, wherein said hydroxy terminated intermediate is polyether.

43. The article of claim 36, wherein said chain extender is selected from the group selected from straight chain glycols having from 2 to 8 carbon atoms.

44. The article of claim 36, wherein said diisocyanate is 4,4′-methylene bis-(phenyl isocyanate).

45. The article of claim 36, wherein said first fully formed TPU polymer is a polyether polyurethane and said second fully formed TPU polymer is a polyester polyurethane.

46. The article of claim 36, wherein said coating film of TPU has a thickness of from about 25 μm to about 400 μm.

47. The article of claim 44, wherein said coating film of TPU has a thickness of from about 90 μm to about 350 μm.

48. The article of claim 36, wherein said fabric is made from fibers selected from the group consisting of organic fibers and inorganic fibers.

49. The article of claim 36, wherein said article is selected from the group consisting of flexible containers, inflatable life vests, inflatable rafts, conveyor belts, inflatable air mattresses, printing blankets, and adhesive laminates.
